(19) United States
(12) Patent Application Publication
(10) Pub. No.: US 2004/0228211 A1
(43) Pub. Date: Nov. 18, 2004

(54) Internal micromixer

(76) Inventors: Chowdary R. Koripella, Scottsdale, AZ (US); Rajnish G. Changrani, Champaign, IL (US); Stephen R. Samms, Mesa, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/437,479

(22) Filed: May 13, 2003

(51) Int. Cl. B01F 13/00

(52) U.S. Cl. 366/341

(57) ABSTRACT

An exemplary system and method for providing substantially uniform mixing of fluid reactants, wherein the flow velocities and/or device dimensions generally correspond to Reynolds numbers less than unity, is disclosed as comprising inter alia: a first fluid inlet (210); a second fluid inlet (220); and a fluid transport channel (240) having a plurality of features (250) corresponding to relatively discontinuous or otherwise abrupt shifts in the fluid transportation gradient. Disclosed features and specifications may be variously controlled, adapted or otherwise optionally modified to improve mixing operation in any diffusion limited application. Exemplary embodiments of the present invention representatively provide for efficient mixing of fluid phases at relatively low Reynolds numbers and may be readily integrated with existing micro-scale technologies for the improvement of device package form factors, weights and other manufacturing and/or device performance metrics.

### FIELD OF INVENTION

The present invention generally concerns systems and methods for uniformly mixing fluid phases wherein the flow velocity corresponds to a Reynolds number generally less than unity; and more particularly, in various representative and exemplary embodiments, to a micro-scale device for mixing at least two liquid, viscous or gaseous reactants.

### BACKGROUND

The mixing of fluids is frequently desired in order to perform chemical reactions. Representatively, a controlled and homogeneous mixing of the reagents is generally desirable. In certain applications or operating environments, the combined volume required for the mixture may need to be kept as small as possible so that the consumption of reagents does not become excessive.

A common conventional means of mixing two or more miscible liquids is to stir, either mechanically with a utensil or by exploiting certain fluidic forces, to produce localized regions corresponding to relatively high fluid flow rates that generally operate to produce localized turbulent forces within the fluid field. This turbulence generally provides a relatively large enough contact surface between the liquids such that diffusion of the fluid components into each other produces a substantially homogeneous mixture. When the flow velocity of a fluid is relatively small, the corresponding Reynolds number R may take on values less than unity as in

$$R = \frac{U d}{v} < 1 ,$$

where U is the mean flow velocity, d the diameter of the flow channel, and v the kinematic viscosity. Low Reynolds number environments may be encountered, for example, in capillary systems, systems where the device scales are relatively small and/or fluid flow velocities are relatively small, or systems where viscous forces largely dominate the inertial forces produced by, for example, high rates of fluid flow. In such cases as these, the inertial forces that produce turbulence and the resulting large contact areas generally required to promote mixing typically cannot be achieved. Accordingly, fluid mixing in these types of systems is generally regarded as a diffusion limited process usually requiring the fluid components to remain in relative contact with each other for prolonged periods of time in order to achieve any substantial mixing. For many applications where two or more fluid components are to be mixed and/or dispensed rapidly in the regimen of low Reynolds numbers, this may be unacceptable. Moreover, while pre-mixing of fluid components in certain liquid phase applications may offer an alternative option, pre-mixing of gas phase reaction components is generally not possible. Accordingly, what may be desired is a system and method for the rapid production of substantially homogeneous fluid mixtures in low Reynolds number regimes.

### SUMMARY OF THE INVENTION

In various representative aspects, the present invention provides an integrated micromixer-microreactor system and method for eliminating the need for pre-mixing of fluid reactants. An exemplary system and method for providing such a device is disclosed as comprising inter alia: a first fluid inlet, a second fluid inlet, and a fluid transport path having substantially orthogonal features corresponding to relatively discontinuous or otherwise abrupt shifts in the fluid transportation gradient. Fabrication of the micromixer devices is relatively simple, inexpensive and straightforward. Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 representatively depicts a cross-sectional view of an inertial micromixer device in accordance with an exemplary embodiment of the present invention; and

FIG. 2 representatively depicts a perspective view of an inertial micromixer device in accordance with another exemplary embodiment of the present invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms ‘front’, ‘back’, ‘top’, ‘bottom’, ‘over’, ‘under’, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

The following descriptions are of exemplary embodiments of the invention and the inventors' conceptions of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a micro-scale system and method for mixing at least two liquid, viscous or gaseous reactants, is provided as a specific enabling disclosure that may be readily generalized by skilled artisans to any application of the disclosed system and method for uniformly mixing fluid phases where the flow velocities generally correspond to Reynolds numbers less than about unity in accordance with various embodiments of the present invention.

Chemical reactions between different species generally rely upon intimate contact between reacting species. Pre-mixing reactant streams in microfluidic channels for microreactor applications has been extremely difficult inasmuch as mixing at the micro-scale is primarily governed by diffusion. As a result of difficulties related to pre-mixing reactant streams before they enter, for example, a microreactor, the reactants are usually pre-mixed prior to being supplied into the microfluidic system.

Specifically, in the development of the combustor for a fuel processor, it is desirable that the hydrogen and the air are substantially thoroughly mixed before coming into contact with, for example, the Pt catalyst. Given the relatively short contact times (i.e., high flow rates), it may be impossible to achieve diffusion aided mixing in the microchannels.

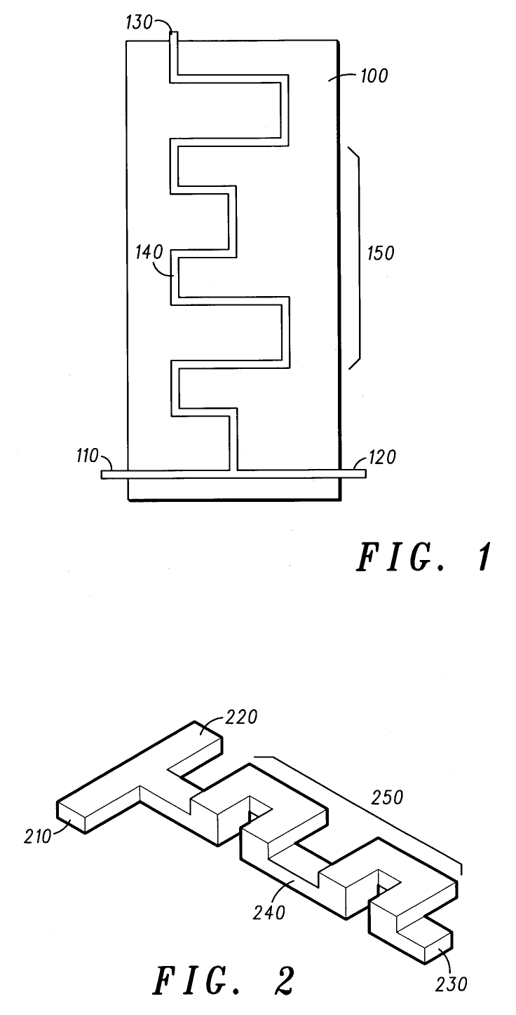

FIG. 1 generally depicts an inertial micromixer for mixing fluid components at relatively low Reynolds number regimes in accordance with one exemplary embodiment of the present invention. Representatively, a first fluid inlet 110 and a second fluid inlet 120 are disposed within a substrate 100 to receive correspondingly supplied fluids for subsequent mixing and discharge from fluid outlet 130. The term “fluid”, as used herein, shall be understood by skilled artisans to mean any fluid, liquid, gas, plasma, other viscous material or any composition or state of matter generally capable of flowing and/or expanding to fill its container.

The substrate may comprise any material, but preferably may include such materials that lend themselves to the production of substantially monolithic device packaging, such as, for example: ceramic; polymeric material; glass; metal; metal alloys; etc . . . Fluid inlets 110 and 120 generally join to meet and supply a flow field to fluid transport channel 140. Transport channel 140 comprises a plurality of jogging substantially angular features 150 that generally provide relatively discontinuous or otherwise abrupt shifts in the fluid transportation gradient so as to enhance inertial mixing of the supplied fluid components. The resulting fluid discharged from outlet 130 corresponds to a more thorough mixture of the fluid components than that corresponding to what may otherwise have been expected for conventional diffusion limited applications.

In one representative and exemplary application, various embodiments of the present invention may be employed, for example, to mix methanol and water in a reformed hydrogen fuel cell and/or a direct methanol fuel cell. Additionally, various embodiments of the present invention have demonstrated the capability to mix a variety of fluids including, for example: gases; liquids: gas-liquid mixtures; etc . . . Other representative applications may include the mixing of fuels supplying a micro-reactor and/or micro-combustion chamber.

In an alternate exemplary embodiment, the present invention may comprise a plurality of three-dimensional angular features 250 that generally provide relatively discontinuous or otherwise abrupt shifts in the fluid transportation gradient so as to enhance inertial mixing of the supplied fluid components flowing through fluid transport channel 240 while generally reducing the absolute distance between fluid inlet ports 210, 220 and fluid outlet port 230 either alone or in integration with a supporting substrate. For any given fluid transport channel constrained to a planar geometry, the extrusion and/or twisting of the channel so as to form a three-dimensional transport path effectively compresses the distance between fluid inlets 210, 220 and fluid outlet 230, which may be advantageous in certain manufacturing and/or device form factor applications. Skilled artisans will appreciate that the geometries depicted in both FIG. 1 and FIG. 2 are provide for representative and convenient illustration and that many other geometries may be alternatively, conjunctively and/or sequentially employed to produce substantially the same result. Representative geometries may include, for example: a regular path; an irregular path; a chaotic path; a fractured path; a corrugated path; etc . . .

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A micro-scale device for inertially mixing at least two fluid phases wherein the dimensions of said device generally correspond to a Reynolds number less than about unity, said device comprising:
a first fluid inlet;
a second fluid inlet;
a fluid transport channel, said channel comprising a plurality of relatively discontinuous shifts in the fluid transportation gradient;
said first fluid inlet and said second fluid inlet communicably connected to said fluid transport channel; and
a fluid outlet, said outlet communicably connected to said channel.

2. The device according to claim 1, further comprising a substantially monolithic substrate.

3. The device according to claim 2, wherein said substrate comprises at least one of ceramic, polymeric material, glass, metal and metal alloy.

4. The device according to claim 1, further comprising a microreactor.

5. The device according to claim 1, wherein at least one of said fluid phases comprises at least one of a gas, a liquid, a plasma and a viscous material.

6. The device according to claim 1, wherein said micromixer device is substantially integrated with a microfluidic device.

7. The device according to claim 1, wherein said micromixer device is suitably adapted to provide a fuel mixture at said fluid outlet.

8. The device according to claim 7, wherein said fluid outlet is communicably connected to a combustion chamber.

9. The device according to claim 8, wherein said combustion chamber comprises a catalyst selected from the group consisting of Pt and Pd.

10. The device according to claim 9, wherein said fuel comprises at least one of hydrogen and air.

11. The device according to claim 1, wherein said micromixer device is integrated with at least one of a reformed hydrogen fuel cell and a direct methanol fuel cell.

12. An device for inertially mixing at least two fluid phases wherein the fluid flow velocity generally corresponds to a Reynolds number less than about unity, said device comprising:
a first fluid inlet;
a second fluid inlet;
a fluid transport channel, said channel comprising a plurality of relatively discontinuous shifts in the fluid transportation gradient;
said first fluid inlet and said second fluid inlet communicably connected to said fluid transport channel; and
an fluid outlet, said fluid outlet communicably connected to said fluid transport channel.

13. A method of using the device according to claim 1, said method comprising the steps of:
supplying a first fluid to said first fluid inlet;
supplying a second fluid to said second fluid inlet;
flowing said first fluid and second fluid through said fluid transport channel in order to mix said first fluid with said second fluid; and
discharging the resulting fluid mixture from said fluid outlet.

14. The method according to claim 13, wherein at least one of said first fluid and said second fluid comprises at least one of a gas, a liquid, a plasma and a viscous material.

15. The method according to claim 14, wherein said fluid mixture comprises a fuel mixture.

16. The method according to claim 15, wherein said fuel mixture comprises at least one of hydrogen and air.

17. The method according to claim 16, wherein said fuel mixture is supplied to at least one of a reformed hydrogen fuel cell and a direct methanol fuel cell.

18. The method according to claim 16, wherein said fluid mixture is supplied to a combustion chamber.

19. A micro-scale device for inertially mixing at least two fluid phases wherein the dimensions of said device generally correspond to Reynolds numbers on the order of laminar flow (e.g., R less than about 2100), said device comprising:
a first fluid inlet;
a second fluid inlet;
a fluid transport channel, said channel comprising a plurality of relatively discontinuous shifts in the fluid transportation gradient;
said first fluid inlet and said second fluid inlet communicably connected to said fluid transport channel; and
a fluid outlet, said outlet communicably connected to said channel.

20. The device according to claim 19, wherein said micromixer device is integrated with at least one of a reformed hydrogen fuel cell and a direct methanol fuel cell.
